(19) United States
(12) Patent Application Publication
(10) Pub. No.: US 2024/0331021 A1
(43) Pub. Date: Oct. 3, 2024

(54) NON-TRANSITORY COMPUTER-READABLE MEDIUM, INFORMATION PROCESSING APPARATUS, AND INFORMATION PROCESSING METHOD

(71) Applicant: Cluster, Inc., Tokyo (JP)

(72) Inventors: Daiki HANDA, Tokyo (JP); Tomotaka OTSUKA, Tokyo (JP)

(73) Assignee: Cluster, Inc., Tokyo (JP)

(21) Appl. No.: 18/612,536

(22) Filed: Mar. 21, 2024

(30) Foreign Application Priority Data
Mar. 29, 2023 (JP) 2023-052497

(51) Int. Cl. G06Q 30/0601

(52) U.S. Cl. CPC G06Q 30/0643

(57) ABSTRACT

A program causes a computer to function as an information processing apparatus including a space data acquisition unit that acquires space data that is three-dimensional data of a virtual reality space in which an exhibition object associated with a product object is arranged, a product information display data acquisition unit that, when an operation for displaying product information related to the product object is performed on the exhibition object by a participant avatar used by a participant participating in the virtual reality space, acquires product information display data for displaying the product information, and a sales unit that, when an operation for purchasing the product object is performed by the participant avatar after the product information is displayed on a basis of the product information display data, sells the product object to the participant who uses the participant avatar.

### CROSS-REFERENCE TO RELATED APPLICATION

This application claims priority to Japanese Patent Application No. 2023-052497, filed Mar. 29, 2023, the entire contents of which are hereby incorporated by reference.

### BACKGROUND

### 1. Technical Field

The present disclosure relates to a non-transitory computer-readable medium, an information processing apparatus, and an information processing method.

### 2. Description of the Related Art

The virtual reality technology is a technology that allows a person to experience a virtual world built on a computer as if it were real. This virtual world is a world constituted by various virtual objects (hereinafter simply referred to as “objects”), and is called a virtual reality space.

A real person (hereinafter referred to as a “participant”) may use an avatar as a virtual self of the participant himself/herself when participating in the virtual reality space. An avatar is a type of object. Hereinafter, the avatar used by the participant and arranged in the virtual reality space is also referred to as a “participant avatar”.

The avatar may wear various items in the virtual reality space. Examples of items that can be worn by the avatar include items for expanding the ability of the avatar, such as items that enable generation of specific sound or specific movement, in addition to items of props such as decorations or items such as clothes. Hereinafter, these items that can be worn by the avatar are collectively referred to as “wearing items”, and the “wearing item” is also a type of object.

Conventionally, there is a technology of selling an avatar or an item such as a decorative article or clothes via a website (for example, JP 4977742 B2).

### SUMMARY

According to the conventional technology, for example, in a case where a participant in the virtual reality space finds an avatar or a wearing item that the participant himself/herself wants to use in the virtual reality space, even if the avatar or the like is available as an object being sold (hereinafter referred to as a “product object”), the participant needs to make a purchase after accessing a website for selling the avatar or the like.

That is, conventionally, there is a problem that there is no technology for selling a product object in a virtual reality space.

The present disclosure solves the above problems, and an exemplary embodiment of the present disclosure includes obtaining a program, an information processing apparatus, and an information processing method capable of selling a product object in a virtual reality space.

A non-transitory computer-readable medium according to the present disclosure stores a program for causing one or more computers to function as an information processing apparatus including a space data acquisition unit that acquires space data that is three-dimensional data of a virtual reality space in which an exhibition object associated with a product object is arranged, a product information display data acquisition unit that, when a product information display operation for displaying product information related to the product object is performed on the exhibition object by a participant avatar used by a participant participating in the virtual reality space expressed by the space data, specifies the product object on a basis of information for specifying the exhibition object or information for specifying the product object included in operation information indicating the product information display operation, and acquires product information display data for displaying the product information included in metadata of the product object; and a sales unit that, when a product purchasing operation for purchasing the product object is performed by the participant avatar after the product information is displayed on a basis of the product information display data, specifies the participant who uses the participant avatar on a basis of information indicating the participant included in the operation information indicating the product purchasing operation, specifies the product object on a basis of information for specifying the exhibition object or information for specifying the product object included in the operation information indicating the product purchasing operation, and sells the product object to the participant, in which when a seller who sells the product object performs an operation for newly arranging the exhibition object in the virtual reality space, the space data acquisition unit acquires the space data of the virtual reality space in which the exhibition object is arranged.

With a program according to the present disclosure, a computer functions as an information processing apparatus that acquires space data of a virtual reality space in which an exhibition object associated with a product object is arranged, acquires product information display data when an operation for displaying product information related to the product object is performed on the exhibition object by a participant avatar, and sells the product object to the participant who uses the participant avatar when an operation for purchasing the product object is performed by the participant avatar after the product information is displayed on the basis of the product information display data. Thus, the program according to the present disclosure can sell the product object in the virtual reality space.

### BRIEF DESCRIPTION OF THE DRAWINGS

FIG. 1 is a block diagram illustrating a configuration of an information processing system according to a first embodiment;

FIG. 2 is a block diagram illustrating hardware components that implement functions of an information processing apparatus according to the first embodiment;

FIG. 3 is a screen view illustrating an example of exhibition of product objects;

FIG. 4 is a screen view illustrating an example of purchase of a product object;

FIG. 5 is a screen view illustrating an example of trial of a product object; and

FIG. 6 is a flowchart illustrating an information processing method according to the first embodiment.

### DETAILED DESCRIPTION

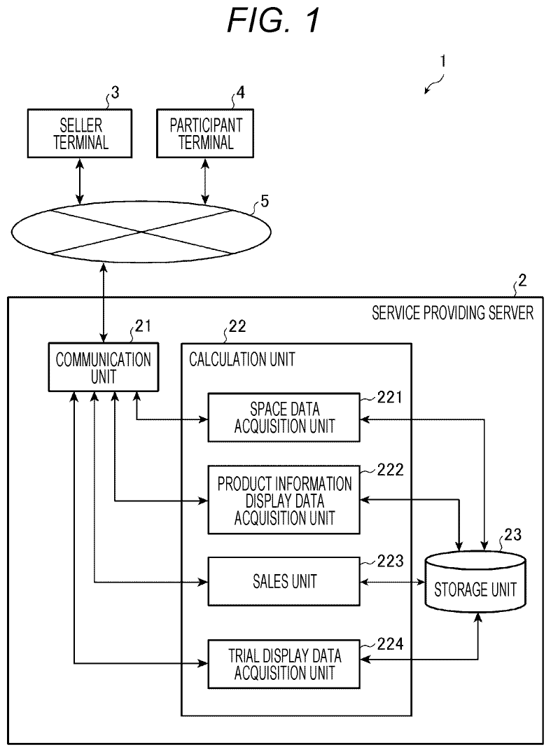

FIG. 1 is a block diagram illustrating a configuration of an information processing system 1 according to an exemplary embodiment. In FIG. 1, the information processing system 1 is a system in which a service providing server 2, a seller terminal 3, and a participant terminal 4 are connected via a network 5. As the network 5, an existing electric communication line can be used. The network 5 is, for example, the Internet. The service providing server 2, the seller terminal 3, and the participant terminal 4 can communicate with each other via the network 5.

### (Outline of Service Providing Server (Information Processing Apparatus))

The service providing server 2 has a function of acquiring space data that is three-dimensional data of a virtual reality space in which an exhibition object associated with a product object is arranged, and acquiring, when an operation for displaying product information related to the product object is performed on the exhibition object by a participant avatar used by a participant participating in the virtual reality space expressed by the space data, product information display data for displaying the product information, and selling, when an operation for purchasing the product object is performed by the participant avatar after the product information is displayed on the basis of the product information display data, the product object to the participant who uses the participant avatar, that is, a function as an information processing apparatus.

In the information processing system 1, the participant terminal 4 may have some or all of the functions of the information processing apparatus. That is, the participant terminal 4 can also function as an information processing apparatus. Furthermore, in the information processing system 1, a part or all of the functions of the information processing apparatus may be provided by the service providing server 2 and the participant terminal 4 in an overlapping manner.

Hereinafter, in a case where there is no particular description, it is assumed that the service providing server 2 that is one server having a physical configuration independent of the participant terminal 4 includes all the functions of the information processing apparatus. However, all of the functions of the information processing apparatus may be implemented by one service providing server 2 or may be implemented by a plurality of service providing servers 2.

Further, the service providing server 2 provides a service related to a virtual reality space represented by space data to users such as participants in the virtual reality space via the network 5. For example, a person who wishes to use the service can register as a user of the service by accessing the service providing server 2 from his or her own terminal and performing a predetermined procedure. The service providing server 2 assigns a unique ID (hereinafter referred to as a “user ID”) to the registered user and manages the user. The service is provided to the user through, for example, a service application installed in a terminal used by the user such as the participant terminal 4.

In addition to the participants in the virtual reality space, the users of the service may include a space creator and a seller of a product object described later. Hereinafter, a description will be given on the assumption that the space creator and the seller of a product object are limited to a person registered as a user of the service. In this case, the space creator ID to be described later may be the same as the user ID of the space creator, and the seller ID to be described later may be the same as the user ID of the seller of the product object.

The service providing server 2 manages the space data. The service providing server 2 can manage a plurality of different pieces of space data. The service providing server 2 manages the space data by assigning a unique ID (hereinafter referred to as “space data ID”) as metadata to each of the plurality of space data.

The service providing server 2 may assign a unique ID (hereinafter referred to as a “space creator ID”) indicating a space creator as metadata to each of the plurality of pieces of space data.

The space creator is a person who has created the space data excluding at least the three-dimensional data of the participant avatar. The space creator can use a terminal for space creation to create, in a known manner, space data for representing the virtual reality space in a state where the participant avatar is not arranged.

For example, the space creator having the user ID can upload the created space data to the service providing server 2 by operating the terminal for space creation. When the space data is uploaded from the terminal for space creation, the service providing server 2 assigns a unique space data ID to the space data, associates the user ID of the space creator therewith, and manages the space data and the name. The service providing server 2 can manage the user ID of the space creator as the space creator ID.

Space data in the middle of being created can be stored in a storage unit included in the terminal for space creation. When creating the space data, the space creator can create the space data while participating in the virtual reality space represented by the space data being created using the avatar, or can create the space data without using the avatar.

In addition, the space creator can upload the space data which has been completed once or the space data which is being created to the service providing server 2. The space creator can directly edit the space data by accessing the space data uploaded to the service providing server 2 and operating the terminal for space creation.

In addition, the service providing server 2 can also allow one or more participants (hereinafter referred to as “general participants”) other than the space creator or the seller to participate in the virtual reality space expressed by the uploaded space data once completed or the space data in the middle of being created. Furthermore, the service providing server 2 can also permit the space creator to edit the space data of the virtual reality space in which the participants are participating, with or without using an avatar.

In addition to the space data ID and the space creator ID, the metadata of the space data may include product information for each of one or more product objects (hereinafter may be simply referred to as “product information”) sold in the virtual reality space expressed by the space data.

The product information of a product object includes information related to sales of the product object, such as a seller ID unique to a seller of the product object, an ID unique to the product object (hereinafter referred to as a “product object ID”), a sales name or an object name of the product object, a sales price of the product object, or an ID unique to an exhibition object associated with the product object (hereinafter referred to as an “exhibition object ID”).

Hereinafter, when simply referred to as “space data”, it is assumed that metadata of the space data is also included.

Note that, in FIG. 1, the information processing system 1 includes only one service providing server 2, but the information processing system 1 may include one or a plurality of service providing servers 2. In a case where the information processing system 1 includes a plurality of service providing servers 2, for example, each of the service providing servers 2 may manage different space data from each other, or in a case where one service providing server 2 manages certain space data, another service providing server 2 may manage duplicated space data as a copy of the space data. Hereinafter, when simply referred to as “space data”, it is assumed that duplicated space data is also included.

In the following description, it is assumed that the information processing system 1 includes one service providing server 2 as illustrated in FIG. 1.

Details of the service providing server 2 including the function as the information processing apparatus will be described later.

(Seller Terminal) The seller terminal 3 is a terminal used when the seller (hereinafter also simply referred to as a “seller”) of the product object makes a preliminary preparation for selling the product object in the virtual reality space. Here, FIG. 1 illustrates only one seller terminal 3. However, the information processing system 1 may include a plurality of seller terminals 3.

The seller of a product object is a person who sells three-dimensional data of the product object.

For example, the seller having the user ID can upload the three-dimensional data of the product object (hereinafter referred to as “product object data”) and the product information as the metadata of the product object data to the service providing server 2 by operating the seller terminal 3. Hereinafter, when simply referred to as “product object data”, it is assumed that metadata of the product object data is also included.

The service providing server 2 stores and manages the product object data uploaded from the seller terminal 3 in a storage unit 23 to be described later. In a case where the product object ID is not included in the product information uploaded from the seller terminal 3, the service providing server 2 assigns a unique product object ID to the product object data and manages the product object data.

In addition, the service providing server 2 can manage the user ID of the seller as the seller ID.

The preliminary preparation means, for example, that the seller obtains permission from the space creator of the virtual reality space in which the seller wishes to sell the product object, and the seller himself/herself performs an operation of arranging an exhibition object associated with the product object in the virtual reality space. More specifically, the operation of arranging the exhibition object associated with the product object in the virtual reality space is an operation of editing the space data of the virtual reality space so that the exhibition object is arranged in the virtual reality space. The seller is given, from the space creator, editing authority regarding at least arrangement of the exhibition object and association between the exhibition object and the product object with respect to the target space data, and for example, after acquiring and editing the space data from the service providing server 2, the seller can upload the edited space data to the service providing server 2.

Furthermore, the preliminary preparation means, for example, obtaining permission from the space creator of the virtual reality space in which the seller wishes to sell the product object, and causing the space creator to edit the space data of the virtual reality space so that the exhibition object associated with the product object is arranged in the virtual reality space.

When editing the space data, the seller or the space creator edits the space data so that the exhibition object is arranged at a desired position in the virtual reality space, and performs an operation of associating (hereinafter referred to as “association operation”) the exhibition object with the product object to be exhibited using the exhibition object.

The association operation is, for example, an operation of editing the space data using the product object data so that the product object is arranged at a predetermined position in the exhibition object.

In a case where the specification of a certain exhibition object is a specification in which only one product object can be arranged in one exhibition object, the seller or the space creator performs an operation of editing the space data so that one product object is arranged in one exhibition object as the association operation.

Furthermore, in a case where the specification of a certain exhibition object is a specification in which a plurality of product objects can be arranged for one exhibition object, the seller or the space creator performs an operation of editing the space data so that one or more product objects is arranged in one exhibition object as the association operation.

When the seller or the space creator performs such an operation using, for example, the terminal for space creation possessed by himself/herself, the terminal registers the exhibition object ID and the product object ID in the metadata of the space data in association with each other.

Furthermore, the association operation is, for example, an operation of registering the product object ID by including it in the metadata of the three-dimensional data (hereinafter, “exhibition object data”) of the exhibition object. The seller or the space creator can display and edit a property of the exhibition object using, for example, the terminal for space creation possessed by the seller or the space creator. The display of the property includes a registration field for entering the product object ID of the product object to be associated with the exhibition object, and the seller or the space creator edits the property by entering the product object ID in the registration field.

When the association operation is performed, the exhibition object ID and the product object ID are registered in the metadata of the space data in association with each other. Furthermore, in this case, the specification of the exhibition object can be a specification in which the product object associated with the exhibition object is arranged at a predetermined position in the exhibition object. That is, the seller or the space creator does not need to specify at which position in the exhibition object the product object is to be arranged when editing the space data. When the virtual reality space is displayed on the basis of the space data, the product object associated with the exhibition object is arranged and displayed at a predetermined position in the exhibition object.

The seller may operate the seller terminal 3 to apply for selling to the space creator of the virtual reality space in which the seller wishes to sell the product object, for preliminary preparation. If permission is obtained from the space creator, the seller can edit the space data so that the exhibition object is arranged in the virtual reality space by himself/herself, or can cause the space creator to edit the space data so that the exhibition object is arranged in the virtual reality space as described above.

The seller terminal 3 may be any device that can display the virtual reality space and can operate the virtual reality space. The seller terminal 3 is, for example, a smartphone, a tablet terminal, or a personal computer (PC). In addition, the seller terminal 3 may be a head mounted display that is used together with a controller and has a communication function.

The storage unit included in the seller terminal 3 can store space data before or during editing. When the seller edits the space data, the seller can edit the space data while participating in the virtual reality space represented by the space data using the avatar, or can edit the space data without using the avatar.

Furthermore, the service providing server 2 can also permit the seller to edit the space data using the avatar or without using the avatar while a general participant is participating in the virtual reality space that is already uploaded and represented by the space data. In this case, when the seller performs an operation of arranging the exhibition object in the virtual reality space, the space data managed by the service providing server 2 is edited in real time, and the exhibition object is arranged in the virtual reality space in which the general participant is participating. The general participant can see how the exhibition object is arranged in real time.

For example, in a case where the seller operates the seller terminal 3 and edits the space data while participating in the virtual reality space using the avatar, the seller wearing the head mounted display on the head and holding the controller in the hand can operate the virtual reality space displayed on the head mounted display by moving the head or the hand or operating a button or the like of the controller.

Note that the seller and the space creator may be the same person. In this case, the seller does not need to obtain permission from another person, and can edit the space data according to the determination of the seller.

(Product Object) The product object is one or more avatars or one or more wearing items sold by a seller among various avatars or wearing items that can be placed in the virtual reality space. Hereinafter, the avatar sold as a product object is also referred to as a “sales target avatar”, and the worn item sold as a product object is also referred to as a “sales target wearing item”.

The entity of the product object is three-dimensional data (product object data) similarly to other objects that are not sold, and the three-dimensional data of the product object includes, for example, three-dimensional shape information, size information, color information, position information, and orientation information of the product object.

As described above, the wearing item as a product object includes an item for expanding an ability of an avatar, such as an item that enables generation of a specific sound or a specific movement, in addition to an item of a prop such as a decorative article or an item of clothes or the like.

Unlike other objects, the item for expanding an ability does not need to include visible three-dimensional data, but here, it is assumed that the item includes three-dimensional data similarly to other objects so as to be treated as an item that can be associated with the exhibition object and arranged in the virtual reality space. The three-dimensional data of the item for expanding an ability is desirably designed such that the appearance or the like of the item expressed in the virtual reality space by the three-dimensional data can indicate the characteristic of the ability to be expanded.

### (Exhibition Object)

The exhibition object may be an object in any form as long as the object has an appearance that enables a participant in the virtual reality space to recognize that, in a state of being associated with a certain product object, the exhibition object is associated with the certain product object and what the associated product object is.

The appearance that enables the participant in the virtual reality space to recognize what the associated product object is typically an appearance having a shape that allows the participant to visually recognize the appearance of the product object as it is.

Note that, even in a state where the exhibition object is associated with a product object, the appearance of the product object associated with the exhibition object may not be visible from a participating avatar at a position away from the exhibition object by a predetermined distance or more.

The entity of the exhibition object is three-dimensional data (exhibition object data) similarly to other objects, and the three-dimensional data of the exhibition object includes, for example, three-dimensional shape information, size information, color information, position information, and orientation information of the exhibition object.

Examples of the exhibition object include an exhibition stand object having a shape of a table on which a product object can be exhibited in a mode of being placed on an upper surface thereof, an exhibition plate object having a shape of a plate on which a product object can be exhibited in a mode of being placed on an upper surface thereof, an exhibition case object having a box shape on which a product object can be exhibited in a mode of being placed in a space therein, a suspended object having an arm shape on which a product object can be exhibited in a mode of being suspended from above, or a shelf object having a shelf shape on which a plurality of product objects can be arranged and placed in up, down, left, and right directions, and the like.

In addition, the exhibition object is not limited to one in which a product object can be arranged in a mode of being placed on the upper surface, and may be one in which the product object can be arranged in a state of being floating at a position separated from the upper surface by a certain distance.

Further, the exhibition object is not limited to one that is arranged in a state of being placed on the ground or the floor in the virtual reality space, and may be one that is arranged in a state of being floating from the ground or the floor.

Furthermore, the exhibition object is not limited to one that can arrange a product object in a fixed mode, and may be one that can be arranged so that the position or direction of the product object appears to move, for example, the exhibition object itself moves or the relative position with respect to the exhibition object moves.

### (Participant Terminal)

The participant terminal 4 is a terminal used when the participant participates in the virtual reality space. The participant accesses the service providing server 2 using the participant terminal 4 and downloads desired space data to the participant terminal 4. The participant participates as an avatar (participant avatar) in the virtual reality space represented by the space data by using the participant terminal 4. The participant may also participate in the virtual reality space in a manner of simply viewing the virtual reality space without using the avatar.

In a case where a participant participates in the virtual reality space as an avatar (participant avatar), the participant can change the state of the participant avatar or other objects by moving the participant avatar, changing the posture of the participant avatar, moving the participant avatar to move or use another object, or the like in the virtual reality space by operating the participant terminal 4.

The participant terminal 4 may be any device that can display the virtual reality space and can operate the virtual reality space. The participant terminal 4 is, for example, a smartphone, a tablet terminal, or a PC. In addition, the participant terminal 4 may be a head mounted display that is used together with a controller and has a communication function.

For example, the participant wearing the head mounted display on the head and holding the controller in the hand can operate the virtual reality space displayed on the head mounted display by moving the head or the hand or operating a button or the like of the controller.

In a case where a participant participates in the virtual reality space as an avatar (participant avatar) by using the participant terminal 4, when the participant operates the participant terminal 4 to change the state of the participant avatar or another object, the participant terminal 4 modifies the downloaded space data on the basis of information indicating the operation (hereinafter referred to as “operation information”), and changes the state of the participant avatar or another object in the virtual reality space. Further, the participant terminal 4 transmits the operation information to the service providing server 2. The service providing server 2 corrects the space data of the virtual reality space in which the participant avatar described above participates among the managed space data on the basis of the operation information acquired from the participant terminal 4, and changes the state of the participant avatar or another object in the virtual reality space.

In this way, the participant terminal 4 and the service providing server 2 can share the states of a participant avatar and an object in one and the same virtual reality space in substantially real time. In other words, the participant terminal 4 and the service providing server 2 can share the space data of one and the same virtual reality space in substantially real time.

Here, FIG. 1 illustrates only one participant terminal 4. However, the information processing system 1 usually includes a plurality of participant terminals 4.

For example, in a case where a plurality of participants participates as avatars (participant avatars) in one and the same virtual reality space from their own participant terminals 4, when acquiring operation information from one participant terminal 4, the service providing server 2 also transmits the operation information to all the other participant terminals 4. Upon acquiring the above-described operation information from the service providing server 2, all the other participant terminals 4 correct the downloaded space data and change the state of the participant avatar or another object in the virtual reality space.

In this way, the plurality of participant terminals 4 and the service providing server 2 can share the states of a participant avatar and an object in one and the same virtual reality space in substantially real time. In other words, the plurality of participant terminals 4 and the service providing server 2 can share the space data of one and the same virtual reality space in substantially real time.

### (Details of Service Providing Server)

Hereinafter, details of the service providing server 2 including the function as the information processing apparatus will be described. As illustrated in FIG. 1, the service providing server 2 includes a communication unit 21, a calculation unit 22, and a storage unit 23.

The communication unit 21 communicates with the seller terminal 3 and the participant terminal 4 via the network 5. Furthermore, for example, the communication unit 21 is a communication device capable of mobile communication by a communication method such as LTE, 3G, 4G, or 5G, and communicates with other devices such as the seller terminal 3 and the participant terminal 4 connected to the network 5. Furthermore, the communication unit 21 may include a near field communication unit such as Bluetooth (registered trademark).

The calculation unit 22 controls the overall operation of the service providing server 2. The calculation unit 22 includes a space data acquisition unit 221, a product information display data acquisition unit 222, a sales unit 223, and a trial display data acquisition unit 224. When the calculation unit 22 executes the information processing application, the functions of the space data acquisition unit 221, the product information display data acquisition unit 222, the sales unit 223, and the trial display data acquisition unit 224 are implemented by the calculation unit 22. These functions are functions as an information processing apparatus.

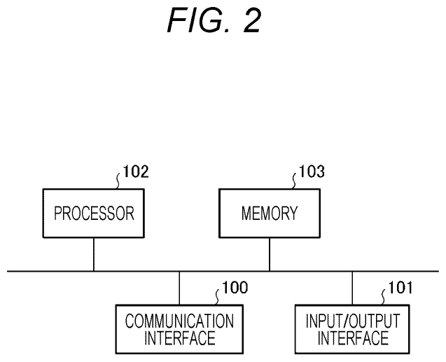

The storage unit 23 stores, for example, an information processing application and information used for arithmetic processing of the calculation unit 22. The storage unit 23 is a storage device included in a computer that functions as the service providing server 2, and includes a storage such as a hard disk drive (HDD) or a solid state drive (SSD), a memory 103 in FIG. 2, or the like. Note that the storage unit 23 only needs to be accessible by the service providing server 2, and may be provided outside the service providing server 2.

FIG. 2 is a block diagram illustrating a hardware configuration that implements the functions of the service providing server 2. For example, the service providing server 2 includes, as a hardware configuration, a communication interface 100, an input/output interface 101, a processor 102, and a memory 103. The functions of the space data acquisition unit 221, the product information display data acquisition unit 222, the sales unit 223, and the trial display data acquisition unit 224 included in the service providing server 2 are implemented by executing the information processing application in these hardware configurations.

The communication interface 100 outputs data received from the seller terminal 3, the participant terminal 4, and the like via the network 5 to the processor 102, and transmits data generated by the processor 102 to the seller terminal 3, the participant terminal 4, and the like via the network 5. The processor 102 reads and writes data from and to the storage unit 23 in FIG. 1 via the input/output interface 101.

A program that configures an information processing application for implementing the respective functions of the space data acquisition unit 221, the product information display data acquisition unit 222, the sales unit 223, and the trial display data acquisition unit 224 included in the service providing server 2 is stored in the storage unit 23. The processor 102 reads the program stored in the storage unit 23 via the input/output interface 101, loads the program into the memory 103, and executes the program loaded into the memory 103. Thus, the processor 102 implements the respective functions of the space data acquisition unit 221, the product information display data acquisition unit 222, the sales unit 223, and the trial display data acquisition unit 224. The memory 103 is, for example, a random access memory (RAM).

### (Space Data Acquisition Unit)

The space data acquisition unit 221 acquires space data that is three-dimensional data of the virtual reality space in which the exhibition object associated with the product object is arranged.

Upon acquiring a participation request to the virtual reality space from the participant terminal 4, the space data acquisition unit 221 acquires the space data of the virtual reality space designated in the participation request from the storage unit 23. In a case where the space data designated in the participation request is the space data of the virtual reality space in which the exhibition object associated with the product object is arranged, the space data acquisition unit 221 acquires the space data.

When the seller who sells the product object performs an operation for newly arranging the exhibition object in the virtual reality space, the space data acquisition unit 221 acquires space data of the virtual reality space in which the exhibition object is arranged.

As described above, as a preliminary preparation for selling the product object in the virtual reality space, the seller can perform an operation for newly arranging the exhibition object in the virtual reality space, that is, edit the space data so that the new exhibition object is arranged in the virtual reality space, and then upload the edited space data to the service providing server 2.

Upon acquiring the edited space data, the service providing server 2 stores the space data in the storage unit 23. At this time, the service providing server 2 can store the edited space data in the storage unit 23 in place of the space data before editing, in other words, in a mode of overwriting the space data before editing.

As described above, when the seller who sells the product object performs an operation for newly arranging the exhibition object in the virtual reality space, the edited space data is stored in the storage unit 23, and thereafter, the space data acquisition unit 221 acquires the edited space data, that is, the space data of the virtual reality space in which the exhibition object is newly arranged.

The space data acquisition unit 221 transmits the acquired space data to the participant terminal 4. Upon acquiring the space data from the space data acquisition unit 221, the participant terminal 4 displays the virtual reality space on a display or the like on the basis of the acquired space data.

As described above, the participant terminal 4 also has a function of acquiring the space data.

Furthermore, the space data acquisition unit 221 can acquire the space data of the virtual reality space in which at least one of the exhibition object associated with a sales target avatar to be sold as the product object or the exhibition object associated with a wearing item (sales target wearing item) that is wearable by any avatar as the product object is arranged.

As described above, the product objects include a sales target avatar or a sales target wearing item, and the seller may sell either type of item object, or may sell both types of item objects. Furthermore, for example, a seller who sells only the sales target avatar or a seller who sells only the sales target wearing item may sell the product object in the same virtual reality space.

Therefore, the space data acquisition unit 221 can acquire the space data of the virtual reality space in which at least one of the exhibition object associated with the sales target avatar or the exhibition object associated with the sales target wearing item is arranged.

### (Product Information Display Data Acquisition Unit)

When an operation for displaying the product information related to the product object is performed on the exhibition object by the participant avatar used by the participant participating in the virtual reality space, the product information display data acquisition unit 222 acquires product information display data for displaying the product information.

The participant changes the state of the participant avatar in the displayed virtual reality space by operating the participant terminal 4, and can perform an operation (hereinafter referred to as “product information display operation”) for displaying the product information related to the product object on the exhibition object.

The product information display operation is, for example, an operation directly or indirectly performed on the exhibition object, such as an operation of causing the participant avatar to touch the exhibition object, an operation of causing the participant avatar to touch the product object displayed in association with the exhibition object, an operation of bringing the participant avatar closer to a predetermined range from the exhibition object, an operation of causing the participant avatar to touch a button object for displaying the product information displayed in the vicinity of the exhibition object, an operation of bringing the participant avatar closer to the predetermined range from the exhibition object and then directing the line of sight of the participant avatar toward the exhibition object or the product object displayed in association with the exhibition object, or an operation of bringing the participant avatar closer to the predetermined range from the exhibition object and then generating a voice for displaying the product information.

Note that, in a case where the participant displays the virtual reality space on a screen of the participant terminal 4 as a normal smartphone, PC, or the like instead of the head mounted display and participates in the virtual reality space, the product information display operation by the participant avatar can also include, for example, an operation of a button for displaying the product information displayed at a position overlapping with a window displaying the virtual reality space on the screen, a position not overlapping with the window, or the like, which is performed after an operation such as bringing the participant avatar close to the predetermined range from the exhibition object is performed.

When the participant performs the product information display operation using the participant terminal 4, the participant terminal 4 transmits operation information indicating the product information display operation to the service providing server 2. The operation information includes, for example, an exhibition object ID as information for specifying an exhibition object that is the target of the product information display operation, or a product object ID as information for specifying a product object associated with the exhibition object.

Upon acquiring the operation information from the participant terminal 4, the product information display data acquisition unit 222 of the service providing server 2 acquires the product information of the product object associated with the exhibition object from the storage unit 23 on the basis of the exhibition object ID or the product object ID included in the operation information.

Here, the product information is stored in the storage unit 23 as metadata of the three-dimensional data of the product object, and is usually text data. Therefore, the terminal such as the participant terminal 4 can display the product information using the text data. In this manner, the product information itself can function as product information display data that is data for displaying the product information.

In addition, the service providing server 2 may have a function of generating product information display data for displaying the product information in a predetermined mode on the basis of the operation information acquired from the storage unit 23, and may cause the product information display data acquisition unit 222 to acquire the product information display data generated by the function. The product information display data in this case may be, for example, data prescribing that each item included in the product information is displayed in a list form, or data of an object in a plate shape or the like on which a text indicating the product information is described on a surface.

Upon acquiring the product information display data, the product information display data acquisition unit 222 transmits the acquired product information display data to the participant terminal 4. Upon acquiring the product information display data, the participant terminal 4 displays the product information on a display or the like on the basis of the acquired product information display data.

As described above, the participant terminal 4 also has a function of acquiring the product information display data.

The participant terminal 4 may display the product information in the virtual reality space or may display the product information outside the virtual reality space. In a case where the participant terminal 4 displays the product information in the virtual reality space, the product information may be displayed as a simple text that enters the field of view of the participant in the virtual reality space, or the product information may be displayed as the above-described object in a plate shape or the like. Furthermore, for example, in particular, in a case where the participant displays the virtual reality space on the screen of the participant terminal 4 as a normal smartphone, PC, or the like instead of the head mounted display and participates in the virtual reality space, the participant terminal 4 may display the product information at a position overlapping with a window displaying the virtual reality space on the screen, a position not overlapping with the window, or the like, independently of the window.

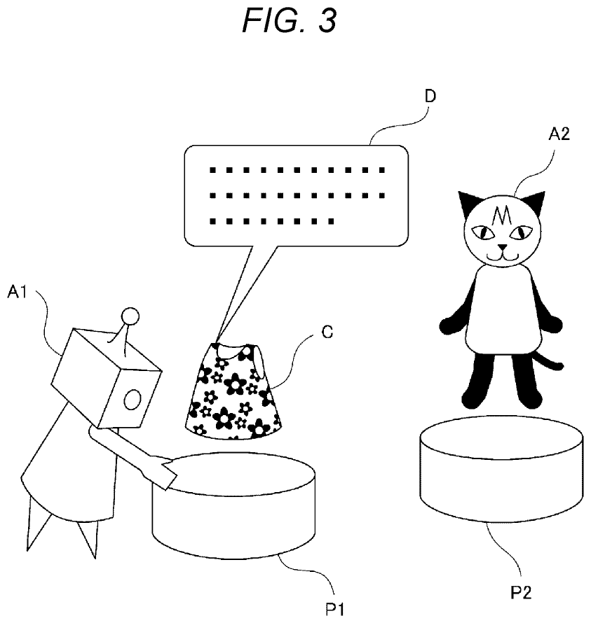

FIG. 3 is a screen view illustrating an example of display of a product object. FIG. 3 illustrates a participant avatar A1, a sales target avatar A2, a sales target wearing item C, an object D indicating product information, and exhibition objects P1 and P2 arranged in the virtual reality space. Note that one or more objects may be arranged in the virtual reality space in addition to the above-described objects illustrated in FIG. 3.

FIG. 3 illustrates a state in which the participant avatar A1 touches the exhibition object P1. When the participant avatar A1 touches the exhibition object P1, the object D indicating the product information of the sales target wearing item C associated with the exhibition object P1 is displayed by the operations of the service providing server 2 and the participant terminal 4 described above.

Note that, from the state illustrated in FIG. 3, when the participant avatar A1 changes to a state of not touching the exhibition object P1, the object D indicating the product information is not displayed immediately or after a predetermined time.

### (Sales Unit)

When an operation for purchasing a product object is performed by the participant avatar after the product information is displayed on the basis of the product information display data, the sales unit 223 sells the product object to the participant who uses the participant avatar.

By operating the participant terminal 4, the participant can change the state of the participant avatar in the virtual reality space and perform an operation for purchasing the product object (hereinafter referred to as “product purchasing operation”).

The product purchasing operation is, for example, an operation of causing the participant avatar to touch a button for purchasing a product displayed on an object indicating the product information, an operation of causing the participant avatar to touch a button object for purchasing a product displayed in the vicinity of the exhibition object, or an operation of bringing the participant avatar close to a predetermined range from the exhibition object and generating a voice for purchasing a product.

Note that, in a case where the participant displays the virtual reality space on the screen of the participant terminal 4 as a normal smartphone, PC, or the like instead of the head mounted display and participates in the virtual reality space, the product purchasing operation by the participant avatar can also include, for example, an operation of a button for purchasing a product displayed at a position overlapping with a window displaying the virtual reality space on the screen, a position not overlapping with the window, or the like, which is performed after an operation such as bringing the participant avatar close to the predetermined range from the exhibition object is performed.

When the participant performs the product purchasing operation using the participant terminal 4, the participant terminal 4 transmits operation information indicating the product purchasing operation to the service providing server 2. In addition to the user ID indicating the participant who has performed the product purchasing operation (hereinafter referred to as a “purchaser”) using the participant avatar, the operation information includes, for example, an exhibition object ID as information for specifying an exhibition object associated with the product object that is the target of the product purchasing operation, or includes a product object ID as information for specifying the product object itself that is the target of the product purchasing operation.

Upon acquiring the operation information from the participant terminal 4, the sales unit 223 of the service providing server 2 acquires the product information of the product object associated with the exhibition object from the storage unit 23 on the basis of the exhibition object ID or the product object ID included in the operation information, and performs processing (hereinafter referred to as “sales processing”) of selling the product object to the purchaser (participant) indicated by the user ID included in the operation information.

For example, the sales unit 223 performs sales processing using currency (hereinafter referred to as “in-service currency”) that can be used only in the service provided by the service providing server 2. In a case where the in-service currency is used, for example, the sales unit 223 subtracts the currency amount indicated by the sales price included in the product information from the balance of the in-service currency of the purchaser stored in the storage unit 23, and adds a predetermined amount to the balance of the seller indicated by the seller ID included in the product information.

The sales unit 223 may use a ticket or the like having an economic value instead of the in-service currency.

Alternatively, the sales unit 223 performs sales processing by accessing an external payment system and making a settlement using digital currency such as virtual currency or electronic money, legal currency other than digital currency, or the like. In either case, the sales unit 223 can specify the purchaser on the basis of the user ID of the purchaser (participant) included in the operation information indicating the product purchasing operation, and can specify the seller on the basis of the seller ID included in the product information of the product object that is the target of the product purchasing operation, so that the sales processing can be performed by making a settlement using these pieces of information.

With such processing of the participant terminal 4 and the service providing server 2, both the participant terminal 4 and the service providing server 2 perform the sales processing without accessing the website for selling the product object. Therefore, by performing the product purchasing operation in a state of participating in the virtual reality space, the participant can purchase a desired product object without displaying the web site for selling the product object and without requiring the participant to perform an operation on the web site.

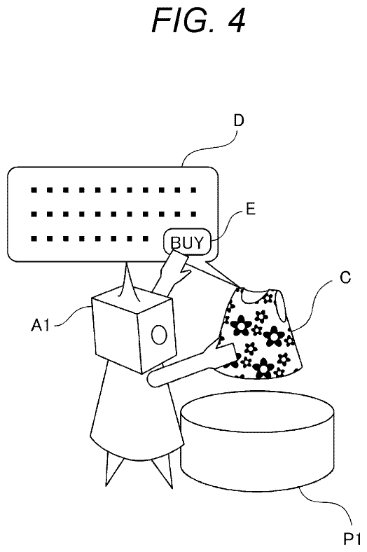

FIG. 4 is a screen view illustrating an example of purchase of a product object. FIG. 4 illustrates the participant avatar A1, the sales target wearing item C, the object D indicating the product information, a button E, and an exhibition object P1 arranged in the virtual reality space.

FIG. 4 illustrates a state in which the participant avatar A1 touches the button E for purchasing the product displayed on the object D indicating the product information. When the participant avatar A1 touches the button E, sales processing is performed by the operations of the service providing server 2 and the participant terminal 4 described above.

Note that, instead of immediately transmitting operation information indicating the product purchasing operation to the service providing server 2 after the product purchasing operation is performed, the participant terminal 4 may display a confirmation button or the like for confirming whether or not to actually purchase in an appropriate manner, and transmit operation information indicating the product purchasing operation to the service providing server 2 after the intention of the participant to purchase is confirmed.

In addition, it can be considered that the participant terminal 4 performs sales processing by accessing the service providing server 2 and making a settlement, or the participant terminal 4 may perform sales processing by accessing an external system and making payment by itself instead of the service providing server 2.

### (Trial Display Data Acquisition Unit)

When an operation for trying the product object is performed on the exhibition object, the trial display data acquisition unit 224 acquires trial display data for displaying a trial state of the product object.

By operating the participant terminal 4, the participant can change the state of the participant avatar in the virtual reality space and perform an operation for trying the product object (hereinafter referred to as “product trial operation”).

The product trial operation is, for example, an operation directly or indirectly performed on the exhibition object, such as an operation of causing the participant avatar to hold the product object displayed in association with the exhibition object or an operation of bringing the participant avatar closer to a predetermined range from the exhibition object, an operation of causing the participant avatar to touch a button object for trying the product displayed in the vicinity of the exhibition object, an operation of bringing the participant avatar closer to the predetermined range from the exhibition object and then directing the line of sight of the participant avatar toward the exhibition object or the product object displayed in association with the exhibition object, or an operation of bringing the participant avatar closer to the predetermined range from the exhibition object and then generating a voice for product trial. The participant can perform the product trial operation at any timing before purchasing the product object.

Note that, in a case where the participant displays the virtual reality space on the screen of the participant terminal 4 as a normal smartphone, PC, or the like instead of the head mounted display and participates in the virtual reality space, the product trial operation by the participant avatar can also include, for example, an operation of a button for trying a product displayed at a position overlapping with a window displaying the virtual reality space on the screen, a position not overlapping with the window, or the like, which is performed after an operation such as bringing the participant avatar close to the predetermined range from the exhibition object is performed.

When the participant performs the product trial operation using the participant terminal 4, the participant terminal 4 corrects the space data downloaded from the service providing server 2 and held by the participant terminal 4 on the basis of operation information indicating the product trial operation, and generates and acquires trial display data for displaying a state in which the participant avatar has tried the product object on the participant terminal 4. The operation information includes, for example, an exhibition object ID as information for specifying an exhibition object that is a target of the product trial operation, or a product object ID as information for specifying a product object associated with the exhibition object.

Further, the participant terminal 4 transmits the operation information to the service providing server 2. The trial display data acquisition unit 224 of the service providing server 2 corrects the above-described space data of the virtual reality space in which the participant avatar participates among the managed space data on the basis of the operation information acquired from the participant terminal 4, and generates and acquires the same trial display data as the trial display data for displaying a state in which the participant avatar in the virtual reality space has tried the product object on the participant terminal 4.

That is, the trial display data is three-dimensional data that is generated and acquired by the participant terminal 4 and the service providing server 2 as described above and indicates a state in which the participant avatar is actually trying the product object.

When the product object to be tried is a sales target avatar, the trial display data is generated so that the sales target avatar is displayed instead of the participant avatar used by a certain participant. In other words, the participant participates in the virtual reality space by using the sales target avatar being tried.

When the product object to be tried is a sales target wearing item, the trial display data is generated such that a state in which the participant avatar used by a certain participant wears the sales target wearing item is displayed.

At least while the product object is being tried, the participant terminal 4 or the service providing server 2 manages, for example, the user ID of the participant who is trying the product object or the ID unique to the participant avatar of the participant in association with the product object ID of the product object being tried.

Note that, by operating the participant terminal 4, the participant can change the state of the participant avatar in the virtual reality space and perform an operation for canceling the trial of the product object (hereinafter referred to as a “trial cancellation operation”).

The trial cancellation operation is, for example, an operation of causing the participant avatar to touch a button object for canceling the trial displayed in the vicinity of the exhibition object or an operation of causing the participant avatar to produce a voice for canceling the trial.

In addition, the product object being tried by the participant may still be arranged and displayed at a predetermined position of the exhibition object, or may not be arranged. The former case is useful, for example, in a case of indicating that, although a certain participant is trying the product object, another participant can try the product object in parallel, and the latter case is useful, for example, in a case of indicating that, while a certain participant is trying the product object, another participant cannot try the product object.

The trial display data acquisition unit 224 may acquire the trial display data for displaying a trial state of the product object in a limited state.

It is useful if the participant can determine whether or not it is necessary to purchase the product object after confirming the state in which the product object has been tried. On the other hand, in the virtual reality technology, the state in which the participant or the participant avatar is simply trying the product object is substantially the same whether the participant or the participant avatar is in trial or after purchase. Therefore, simply enabling the product object to be tried is not preferable for the seller of the product object. For example, when the participant can try the product object without any limitation, there is no motivation for the participant to purchase the product object. For this reason, in the trial of the product object by the participant, it is necessary to consider a balance of interests between the participant and the seller.

By acquiring trial display data for displaying a trial state of a product object in a limited state, the trial display data acquisition unit 224 can add a certain limitation to the trial mode of the product object, and can adjust the balance of interests between the participant and the seller.

Information about how to limit the trial state (hereinafter referred to as “limitation definition information”) is included in the metadata of the space data, for example. The content of limitation by the limitation definition information may be uniformly determined for a product object sold in a certain virtual reality space, or may be determined for each exhibition object or each product object. When the content of limitation by the limitation definition information is determined for each exhibition object or each product object, the limitation definition information is included in the metadata of the exhibition object data or the metadata of the product object data.

In addition, the limitation definition information may be included in the metadata of the trial display data.

Since the participant terminal 4 and the service providing server 2 can share the space data of one and the same virtual reality space almost in real time, limitation of the state can be performed in both the participant terminal 4 and the service providing server 2.

For example, the trial display data acquisition unit 224 acquires the trial display data for displaying the trial state of the product object only within a range of a specific distance, on the basis of the operation information at the time when an operation for trying the product object is performed.

The operation information indicating the product trial operation may include position information of the participant avatar at the time when the product trial operation is performed. For example, the trial display data may be enabled only within a range of a specific distance from the position of the participant avatar at the time when the participant or participant avatar performs the product trial operation. The range of the specific distance is, for example, within a range of a circle having a particular radius about the position of the participant avatar at the time when the participant or participant avatar performs the product trial operation.

Furthermore, for example, the trial display data may be enabled only within a range of a specific distance from the exhibition object associated with the product object being tried by the participant or the participant avatar. The range of the specific distance is, for example, within a range of a circle having a specific radius centered on the exhibition object. Alternatively, the range of the specific distance is, for example, a range of an outer shape of the exhibition object viewed from above.

Without being limited thereto, the specific distance can be set in any manner.

For example, in a case where the participant terminal 4 and the service providing server 2 determine that the sales target avatar being tried by the participant or the participant avatar trying on the sales target wearing item has come out of the range of the specific distance, the participant terminal 4 and the service providing server 2 cancel the trial state, return the sales target avatar being tried by the participant to the participant avatar, and return the participant avatar being tried on the sales target wearing item to the participant avatar not wearing the sales target wearing item.

Alternatively, the participant terminal 4 and the service providing server 2 may limit the movement of the sales target avatar being tried by the participant or the participant avatar trying on the sales target wearing item so that the avatar in the trial state cannot go out of the range of the specific distance.

Furthermore, for example, the trial display data acquisition unit 224 may acquire the trial display data for displaying the trial state of the product object only within a range of a specific time after an operation for trying the product object is performed on the exhibition object.

The specific time can be arbitrarily set. The specific time may be, for example, about 1 to 10 minutes, or may be a time of other length.

In this case, in a case where the participant terminal 4 and the service providing server 2 determine that a specific time has elapsed after the product trial operation is performed for the sales target avatar being tried by the participant or the participant avatar trying on the sales target wearing item, the participant terminal 4 and the service providing server 2 cancel the trial state, return the sales target avatar being tried by the participant to the participant avatar, and return the participant avatar being tried on the sales target wearing item to the participant avatar not wearing the sales target wearing item.

In this case, for example, the trial display data acquisition unit 224 may acquire the trial display data for displaying the trial state of the product object together with an indicator indicating a remaining time of a specific time.

Upon acquiring the trial display data for displaying the trial state of the product object together with the indicator, the participant terminal 4 and the service providing server 2 measure the elapsed time after the product trial operation is performed for the sales target avatar being tried by the participant or the participant avatar trying on the sales target wearing item, and calculate the remaining time.

Then, the participant terminal 4 displays an indicator indicating the remaining time of the specific time on the basis of the calculated remaining time.

The participant terminal 4 may display an indicator in the virtual reality space or may display an indicator outside the virtual reality space.

In a case where the participant terminal 4 displays the indicator in the virtual reality space, the indicator may be displayed as a remaining time of a simple text that enters the field of view of the participant in the virtual reality space, the indicator may be displayed as an object in which the remaining time is described on a surface, or the indicator may be displayed as an object (for example, an hourglass object) that represents the remaining time in an image. In this case, the participant terminal 4 may display the indicator in the vicinity of the sales target avatar being tried by the participant or the participant avatar trying on the sales target wearing item, or may display the indicator at a certain position in the field of view of the participant.

Furthermore, for example, in particular, in a case where the participant participates in the virtual reality space by displaying the virtual reality space on the screen of the participant terminal 4 as a normal smartphone, PC, or the like instead of the head mounted display, the participant terminal 4 may display the indicator at a position overlapping with a window displaying the virtual reality space on the screen, a position not overlapping with the window, or the like, independently of the window.

Furthermore, for example, the trial display data acquisition unit 224 may acquire the trial display data for displaying the trial state of the product object so that only the participant (hereinafter referred to as a “trying participant”) using the participant avatar that has performed an operation for trying the product object can visually recognize the trial state of the product object.

This limitation is particularly a limitation of the trial state in a case where a plurality of participants simultaneously participates in the same virtual reality space. In a case where the trial display data acquisition unit 224 limits the trial state of the product object as described above, the service providing server 2 does not transmit the trial display data acquired by the trial display data acquisition unit 224 to at least one or more participant terminals 4 used by one or more participants other than the trying participant, respectively. On the other hand, the service providing server 2 transmits data of the participant avatar that is the participant avatar of the trying participant and is not in a trial state to one or more participant terminals 4 used by one or more participants other than the trying participant, respectively.

Therefore, one or more participants other than the trying participant simply visually recognize the participant avatar that is the participant avatar of the trying participant and is not in a trial state without visually recognizing the sales target avatar being tried by the trying participant or the participant avatar trying on the sales target wearing item.

Furthermore, for example, the trial display data acquisition unit 224 may acquire the trial display data for displaying the trial state of the product object so that another participant other than the participant using the participant avatar (trying participant) who has performed at least an operation for trying the product object can determine that the product object is in a trial state.

This limitation is also particularly a limitation of the trial state in a case where a plurality of participants simultaneously participates in the same virtual reality space.

In a case where the trial display data acquisition unit 224 limits the trial state of the product object as described above, the trial display data acquisition unit 224 of the participant terminal 4 and the service providing server 2 does not simply generate and acquire the trial display data as three-dimensional data indicating a state in which the participant avatar is actually trying the product object, but generates and acquires the trial display data so that at least one or more participants other than the trying participant can determine that the product object is in a trial state.

In this case, for example, the trial display data acquisition unit 224 of the participant terminal 4 and the service providing server 2 generates and acquires trial display data for displaying the sales target avatar being tried by the participant or the participant avatar trying on the sales target wearing item in such a manner that a part or the whole thereof is displayed in a lighter color than the color when it is not tried, displayed by changing a portion that is opaque when it is not tried to translucent, or displayed in a blurred appearance than the appearance when it is not tried, or that a character or the like indicating that the avatar is trying is arranged and displayed in the vicinity thereof, or that a periphery thereof is surrounded with a frame.

The service providing server 2 transmits the trial display data acquired by the trial display data acquisition unit 224 to at least one or more participant terminals 4 used by one or more participants other than the trying participant, respectively.

Thus, all the participants can visually recognize the sales target avatar being tried by the trying participant or the participant avatar trying on the sales target wearing item in a mode in which it can be determined that it is in a trial state.

Furthermore, in this case, for example, the participant terminal 4 may simply generate and acquire the trial display data as three-dimensional data indicating the state in which the participant avatar is actually using the product object, and on the other hand, the trial display data acquisition unit 224 of the service providing server 2 may generate and acquire the trial display data such that at least one or more participants other than the trying participant can understand that the product object is in a trial state. The service providing server 2 transmits the trial display data acquired by the trial display data acquisition unit 224 to one or more participant terminals 4 used by one or more participants other than the trying participant, respectively.

Thus, one or more participants other than the trying participant can visually recognize the sales target avatar being tried by the participant or the participant avatar trying on the sales target wearing item in a mode in which it can be determined that it is in a trial state.

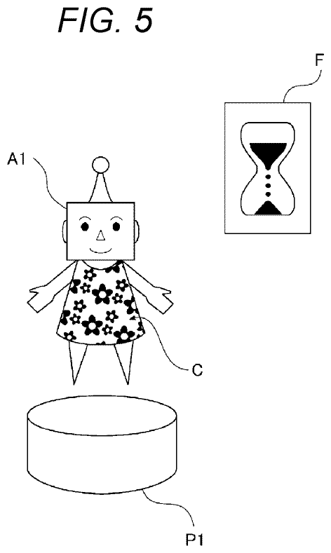

FIG. 5 is a screen view illustrating an example of a trial of a product object. FIG. 5 illustrates the participant avatar A1, the sales target wearing item C, an indicator object F, and the exhibition object P1 arranged in the virtual reality space. FIG. 5 illustrates a state in which the participant avatar A1 is trying the one-piece shaped sales target wearing item C.

In FIG. 5, the participant avatar who is trying the sales target wearing item is displayed to be in a trial state only within the range of the outer shape of the exhibition object P1 viewed from above as the range of the specific distance.

Furthermore, in FIG. 5, the indicator object F is an hourglass object, has a role as an indicator indicating the remaining time of the specific time, and has a role of displaying the participant avatar A1 trying on the sales target wearing item in a mode in which the participant avatar A1 is in a trial state.

### (Information Processing Method)

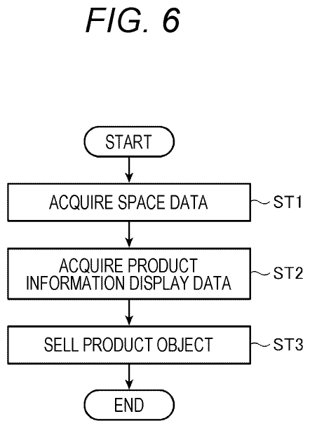

FIG. 6 is a flowchart illustrating an information processing method according to the first embodiment.

The space data acquisition unit 221 acquires space data that is three-dimensional data of the virtual reality space in which the exhibition object associated with the product object is arranged (step ST1).

When an operation for displaying the product information related to the product object is performed on the exhibition object by the participant avatar used by the participant participating in the virtual reality space expressed by the space data, the product information display data acquisition unit 222 acquires the product information display data for displaying the product information (step ST2).

When an operation for purchasing the product object is performed by the participant avatar after the product information is displayed on the basis of the product information display data, the sales unit 223 sells the product object to the participant who uses the participant avatar (step ST3).

Note that the functions of the information processing apparatus included in the service providing server 2 or the participant terminal 4 only need to include at least the functions of the space data acquisition unit 221, the product information display data acquisition unit 222, and the sales unit 223, and the trial display data acquisition unit 224 is a function arbitrarily added.

As described above, the service providing server 2 or the participant terminal 4 (information processing apparatus) according to the first embodiment includes the space data acquisition unit 221 that acquires three-dimensional data of a virtual reality space in which an exhibition object associated with a product object is arranged, the product information display data acquisition unit 222 that, when an operation for displaying product information related to the product object is performed on the exhibition object by a participant avatar used by a participant participating in the virtual reality space expressed by the space data, acquires product information display data for displaying the product information, and the sales unit 223 that, when an operation for purchasing the product object is performed by the participant avatar after the product information is displayed on the basis of the product information display data, sells the product object to the participant who uses the participant avatar.

Therefore, by being executed by the one or more computers, a program according to the first embodiment that causes one or more computers to function as the service providing server 2 or the participant terminal 4 (information processing apparatus) can sell a product object in the virtual reality space. Then, by performing the product purchasing operation in a state of participating in the virtual reality space, the participant to the virtual reality space can purchase a desired product object without displaying the web site for selling the product object and without requiring the participant to perform an operation on the web site.

In the service providing server 2 or the participant terminal 4 (information processing apparatus) according to the first embodiment, when a seller who sells the product object performs an operation for newly arranging the exhibition object in the virtual reality space, the space data acquisition unit 221 may acquire the space data of the virtual reality space in which the exhibition object is arranged.

In this case, by being executed by the one or more computers, the program according to the first embodiment that causes one or more computers to function as the service providing server 2 or the participant terminal 4 (information processing apparatus) enable a seller to arrange an exhibition object at an intended place in the virtual reality space and to freely sell a product object desired to be sold.

The service providing server 2 or the participant terminal 4 (information processing apparatus) according to the first embodiment may include the trial display data acquisition unit 224 that, when an operation for trying the product object is performed on the exhibition object, acquires trial display data for displaying a trial state of the product object.

In this case, by being executed by the one or more computers, the program according to the first embodiment that causes one or more computers to function as the service providing server 2 or the participant terminal 4 (information processing apparatus) enables the participant to visually recognize the product object in the trial state in the virtual reality space.

In the service providing server 2 or the participant terminal 4 (information processing apparatus) according to the first embodiment, the trial display data acquisition unit 224 may acquire the trial display data for displaying the trial state of the product object in a limited state.

In this case, by being executed by the one or more computers, the program according to the first embodiment that causes one or more computers to function as the service providing server 2 or the participant terminal 4 (information processing apparatus) can impose a certain limitation on a trial mode of the product object, and can adjust the balance of interests between the participant and the seller.

In the service providing server 2 or the participant terminal 4 (information processing apparatus) according to the first embodiment, the trial display data acquisition unit 224 may acquire the trial display data for displaying the trial state of the product object only within a range of a specific distance, on the basis of operation information at the time when the operation for trying the product object is performed.

In this case, by being executed by the one or more computers, the program according to the first embodiment that causes one or more computers to function as the service providing server 2 or the participant terminal 4 (information processing apparatus) to impose a limitation that the trial state of the product object is displayed only within a specific distance on the trial state of the product object.

In the service providing server 2 or the participant terminal 4 (information processing apparatus) according to the first embodiment, the trial display data acquisition unit 224 may acquire the trial display data for displaying the trial state of the product object only within a range of a specific time after the operation for trying the product object is performed on the exhibition object.

In this case, by being executed by the one or more computers, the program according to the first embodiment that causes one or more computers to function as the service providing server 2 or the participant terminal 4 (information processing apparatus) can impose a limitation, on the trial state of the product object, that the trial state of the product object is displayed only within a range of a specific time after an operation for trying the product object is performed on the exhibition object.

In the service providing server 2 or the participant terminal 4 (information processing apparatus) according to the first embodiment, the trial display data acquisition unit 224 may acquire the trial display data for displaying the trial state of the product object together with an indicator indicating a remaining time of the specific time.

In this case, by being executed by the one or more computers, the program according to the first embodiment that causes one or more computers to function as the service providing server 2 or the participant terminal 4 (information processing apparatus) enables at least the participant who is trying the product object to visually recognize the remaining time of the specific time.

In the service providing server 2 or the participant terminal 4 (the information processing apparatus) according to the first embodiment, the trial display data acquisition unit 224 may acquire the trial display data for displaying the trial state of the product object in such a manner that only the participant (the participant in use) using the participant avatar that has performed the operation for trying the product object is able to visually recognize the trial state of the product.

In this case, by being executed by the one or more computers, the program according to the first embodiment that causes one or more computers to function as the service providing server 2 or the participant terminal 4 (information processing apparatus) enables at least one or more participants other than the trying participant to simply visually recognize the participant avatar of the trying participant and the participant avatar that is not in the trial state without visually recognizing the product object in the trial state by the trying participant.

In the service providing server 2 or the participant terminal 4 (information processing apparatus) according to the first embodiment, the trial display data acquisition unit 224 may acquire the trial display data for displaying the trial state of the product object in such a manner that at least another participant other than the participant using the participant avatar that has performed the operation for trying the product object is able to determine that the product object is in the trial state.

In this case, by being executed by the one or more computers, the program according to the first embodiment that causes one or more computers to function as the service providing server 2 or the participant terminal 4 (information processing apparatus) enables at least one or more participants other than the trying participant to visually recognize the product object being tried by the trying participant in a mode in which it can be determined that it is in a trial state.

In the service providing server 2 or the participant terminal 4 according to the first embodiment, the space data acquisition unit 221 acquires the space data of the virtual reality space in which at least one of the exhibition object associated with a sales target avatar to be sold as the product object or the exhibition object associated with a wearing item that is wearable by any avatar as the product object is arranged.

In this case, by being executed by the one or more computers, the program according to the first embodiment that causes one or more computers to function as the service providing server 2 or the participant terminal 4 (information processing apparatus) can sell an avatar (sales target avatar) or a wearing item (sales target wearing item) as a product object in the virtual reality space.

The service providing server 2 or the participant terminal 4 (information processing apparatus) according to the first embodiment that executes the program according to the first embodiment can sell a product object in a virtual reality space.

An information processing method according to the first embodiment includes acquiring, by a space data acquisition unit 221, space data that is three-dimensional data of a virtual reality space in which an exhibition object associated with a product object is arranged, acquiring, by a product information display data acquisition unit 222, when an operation for displaying product information related to the product object is performed on the exhibition object by a participant avatar used by a participant participating in the virtual reality space expressed by the space data, product information display data for displaying the product information, and selling, by a sales unit 223, when an operation for purchasing the product object is performed by the participant avatar after the product information is displayed on the basis of the product information display data, the product object to the participant who uses the participant avatar.

Thus, the information processing method according to the first embodiment can sell the product object in the virtual reality space.

What is claimed is:

1. A non-transitory computer-readable storage medium storing computer-readable instructions thereon which, when executed by one or more computers, cause the one or more computers to perform a method, the method comprising:
acquiring space data that is three-dimensional data of a virtual reality space in which an exhibition object associated with a product object is arranged;
in response to a product information display operation for displaying product information related to the product object is performed on the exhibition object by a participant avatar used by a participant participating in the virtual reality space expressed by the space data, specifying the product object based on information for specifying the exhibition object or information for specifying the product object included in operation information indicating the product information display operation, and acquiring product information display data for displaying the product information included in metadata of the product object; and
in response to a product purchasing operation for purchasing the product object is performed by the participant avatar after the product information is displayed based on the product information display data, specifying the participant who uses the participant avatar based on information indicating the participant included in the operation information indicating the product purchasing operation, specifying the product object based on information for specifying the exhibition object or information for specifying the product object included in the operation information indicating the product purchasing operation, and selling the product object to the participant, wherein
in response to a seller who sells the product object performing an operation for newly arranging the exhibition object in the virtual reality space, acquiring the space data of the virtual reality space in which the exhibition object is arranged.

2. A non-transitory computer-readable storage medium storing computer-readable instructions thereon which, when executed by a computer, cause the computer to perform a method, the method comprising:
acquiring space data that is three-dimensional data of a virtual reality space in which an exhibition object associated with a product object is arranged;
in response to a product information display operation for displaying product information related to the product object is performed on the exhibition object by a participant avatar used by a participant participating in the virtual reality space expressed by the space data, specifying the product object based on information for specifying the exhibition object or information for specifying the product object included in operation information indicating the product information display operation, and acquiring product information display data for displaying the product information included in metadata of the product object;
in response to a product purchasing operation for purchasing the product object being performed by the participant avatar after the product information is displayed based on the product information display data, specifying the participant who uses the participant avatar based on information indicating the participant included in the operation information indicating the product purchasing operation, specifying the product object based on information for specifying the exhibition object or information for specifying the product object included in the operation information indicating the product purchasing operation, and selling the product object to the participant; and
in response to a product trial operation for trying the product object being performed on the exhibition object, specifying the product object based on information for specifying the exhibition object or information for specifying the product object included in operation information indicating the product trial operation, and acquiring trial display data for displaying a trial state of the product object.

3. The non-transitory computer-readable storage medium according to claim 2, the method further comprising:
acquiring the trial display data for displaying the trial state of the product object in a limited state.

4. The non-transitory computer-readable medium according to claim 2, the method further comprising:
acquiring the trial display data for displaying the trial state of the product object only within a range of a specific distance, based on a position information of the participant avatar at time when the product trial operation included in operation information indicating the product trial operation is performed.

5. The non-transitory computer-readable medium according to claim 2, the method further comprising:
acquiring the trial display data for displaying the trial state of the product object only within a range of a specific time after the product trial operation is performed on the exhibition object.

6. The non-transitory computer-readable medium according to claim 5, the method further comprising:
acquiring the trial display data for displaying the trial state of the product object together with an indicator indicating a remaining time of the specific time.

7. The non-transitory computer-readable medium according to claim 2, the method further comprising:
acquiring the trial display data for displaying the trial state of the product object in such a manner that only the participant using the participant avatar that has performed the product trial operation is able to visually recognize the trial state of the product.

8. The non-transitory computer-readable medium according to claim 2, the method further comprising:
acquiring the trial display data for displaying the trial state of the product object in such a manner that at least another participant other than the participant using the participant avatar that has performed the product trial operation is able to determine that the product object is in the trial state.

9. The non-transitory computer-readable medium according to claim 1, the method further comprising:
acquiring the space data of the virtual reality space in which at least one of the exhibition object associated with a sales target avatar to be sold as the product object or the exhibition object associated with a wearing item that is wearable by any avatar as the product object is arranged.

10. The non-transitory computer-readable medium according to claim 2, the method further comprising:
acquiring the space data of the virtual reality space in which at least one of the exhibition object associated with a sales target avatar to be sold as the product object or the exhibition object associated with a wearing item that is wearable by any avatar as the product object is arranged.

11. An information processing apparatus that executes the computer-readable instructions according to claim 1.

12. An information processing apparatus that executes the computer-readable instructions according to claim 2.

13. An information processing method performed by an information processing apparatus, the method comprising:
acquiring, by processing circuitry, space data that is three-dimensional data of a virtual reality space in which an exhibition object associated with a product object is arranged;
specifying, by the processing circuitry, in response to a product information display operation for displaying product information related to the product object is performed on the exhibition object by a participant avatar used by a participant participating in the virtual reality space expressed by the space data, the product object based on information for specifying the exhibition object or information for specifying the product object included in operation information indicating the product information display operation, and acquiring product information display data for displaying the product information included in metadata of the product object; and
specifying, by the processing circuitry, in response to a product purchasing operation for purchasing the product object is performed by the participant avatar after the product information is displayed based on the product information display data, the participant who uses the participant avatar on a basis of information indicating the participant included in the operation information indicating the product purchasing operation, specifying the product object based on information for specifying the exhibition object or information for specifying the product object included in the operation information indicating the product purchasing operation, and selling the product object to the participant, wherein
in response to a seller who sells the product object performing an operation for newly arranging the exhibition object in the virtual reality space, acquiring the space data of the virtual reality space in which the exhibition object is arranged in the acquiring the space data.
